(19) United States
(12) Patent Application Publication
(10) Pub. No.: US 2008/0114633 A1
(43) Pub. Date: May 15, 2008

(54) Method and Apparatus for Analyzing Activity in a Space

(76) Inventors: Wayne Wolf, Atlanta, GA (US); Philip Otto, Philadelphia, PA (US); Burak Ibrahim Ozer, North Wales, PA (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/939,184

(22) Filed: Nov. 13, 2007

Related U.S. Application Data
(60) Provisional application No. 60/865,239, filed on Nov. 10, 2006.

(51) Int. Cl. G06F 17/30; G06K 9/00

(52) U.S. Cl. 705/7; 382/103

(57) ABSTRACT

The present invention provides a system and a method for analyzing activity of people in a of people in a space. Continuous raw video imagery is received from one or more sensors placed in a pre-defined regions of the space. This imagery is analyzed to determine basic characteristics of the behavior and/or activity of people hi its field-of-view, such as position, movement, etc. Useful data and metrics can he computed, based on the results of imagery analysis. The data analysis results can be provided as a response to user's request or as a running report. Data analysis can optionally combine imagery analysis results with secondary information.

### FIELD OF THE INVENTION

The present invention is generally directed to applications related to activity in a space and more specifically to analyzing human activity over time, over space and across multiple people.

### BACKGROUND OF THE INVENTION

Retailers often use observers to understand how people use their stores. Paco Underhill, author of Why We Buy, is one well-known practitioner of this art. Observers can obtain much useful information and can notice subtle and unexpected things. But retailers cannot deploy observers continuously in their stores, so the information they obtain is only a small sample of the activity in their store.

Many different technologies have been used to count people in stores. Electric eyes and infrared beams are used in many locations. However, such systems cannot count multiple simultaneously passing people and are less accurate when people are not tunneled through narrow areas for counting. VideoMining, Inc. supplies video traffic counting software. Their system also categorizes people based on appearance.

A great deal of work has been put into developing algorithms for the analysis of human activity and tracking of people and other objects. But, none of this work directly makes use of such algorithms to go beyond that work and provide interesting and useful analysis of the human activity over time, over space, and across multiple people.

Therefore, a need exists for a method for a system and method for analyzing human activity over time, over space, and across multiple people.

### SUMMARY OF THE INVENTION

[NOTE FOR ROHINI: INSERT BROAD CLAIMS HERE UPON FINAL]

### BRIEF DESCRIPTION OF THE DRAWINGS

The invention can be understood from the detailed description of exemplary embodiments presented below, considered in conjunction with the attached drawings, of which:

FIG. 1 illustrates an exemplary public space that utilizes the method and the system of one embodiment of the present invention.

FIG. 2 illustrates an exemplary sample decomposition of the exemplary public space of FIG. 1

FIG. 3 illustrates an exemplary region graph that models the regional organization of the exemplary public space of FIG 2.

FIG. 4 illustrates an exemplary block diagram of the system in accordance with an embodiment of the present invention.

FIG. 5 shows an exemplary client table of a database in accordance with one embodiment of the present invention.

FIG. 6 shows an exemplary user table of a database in accordance with another embodiment of the present invention.

FIG. 7 shows an exemplary store table of a database in accordance with another embodiment of the present invention.

FIG. 8 shows an exemplary regions table of a database in accordance with an additional embodiment of the present invention,

FIG. 9 shows an exemplary cameras table of a database in accordance with a further embodiment of the present invention.

FIG. 10 shows an exemplary region data table of a database in accordance with even further embodiment of the present invention.

FIG. 11 illustrates an exemplary web page from the user interface in a preferred embodiment of the present invention.

FIG. 12 shows an exemplary video frame output from the video analysis module of the present invention.

FIG. 13 is an exemplary block diagram for processing a data analysis request.

FIG. 14 is an exemplary block diagram for processing a user request with secondary information.

It is to be understood that the attached drawings are for purposes of illustrating the concepts of the invention and may not be to scale.

### DETAILED DESCRIPTION OF THE INVENTION

Definitions:

The present application uses words in their everyday meanings and terms which are familiar to the arts of computer system design, computer vision, and retail sales. Defined below here a few special terms that are used to describe the invention.

Space: A particular extent of surface.

Sensor/Camera: A device for taking images in visible light, infrared, or other bands or a combination of bauds. Sensors/Cameras may use traditional optics or non-traditional optics

Sensor/Camera server: A device that provides imagery in any of a number of formats. The camera/sensor server may optionally provide some video analysis functions.

Client: An entity that makes use of the analysis system, such as a retail chain.

User: A person who uses the analysis system, such as examining data or making queries to the system. Users are typically but not exclusively employed by clients.

Video analysis: The process of extracting information such as customer counts and customer movements from images or video. The term video is used broadly to mean both full-motion moving pictures and what people would perceive as jerky or irregular image sequences.

Channel: A single video sequence or stream,

Customer: A person who is not an employee.

Employee: A person employed by the store.

Person: Generally, either an employee or a customer. A few people may fall into neither category, such as safety inspectors. It is generally assumed here that the numbers of people who are neither customers nor employees is small and can be dealt with in analysis.

User interface: An input and output mechanism for users, which could be implemented in any number of forms, including but not limited to a web interface or a program written in a standard programming language.

Traffic analysis: Analysis of customer (or possibly employee) information derived from video analysis, possibly in combination with other sources, such as sales data or manually gathered customer information.

Flow: The movement of people from one region to another.

Region: An area of the store.

Customer volume: The number of customers at a given time or in a given interval.

Dwelt time: The amount of time that customers spend in an region or set of regions.

Customer flow: The number of customers who move across given boundaries in a given time interval.

Merchandise conversion rate: A measure relating customer activity to for example, sales, such as dollars spent per customer in a given time interval and region.

Item conversion rate: A merchandise conversion rate value for a specific item or set of items.

Applications and Environment:

Note that the present invention was motivated by the need of retailers to analyze the activities of customers in space such as retail stores, however, the present invention is not limited to retail and could be used in other environments where the flow and activities of people are important, such as transportation facilities, sports facilities, restaurants, parks, or other environments.

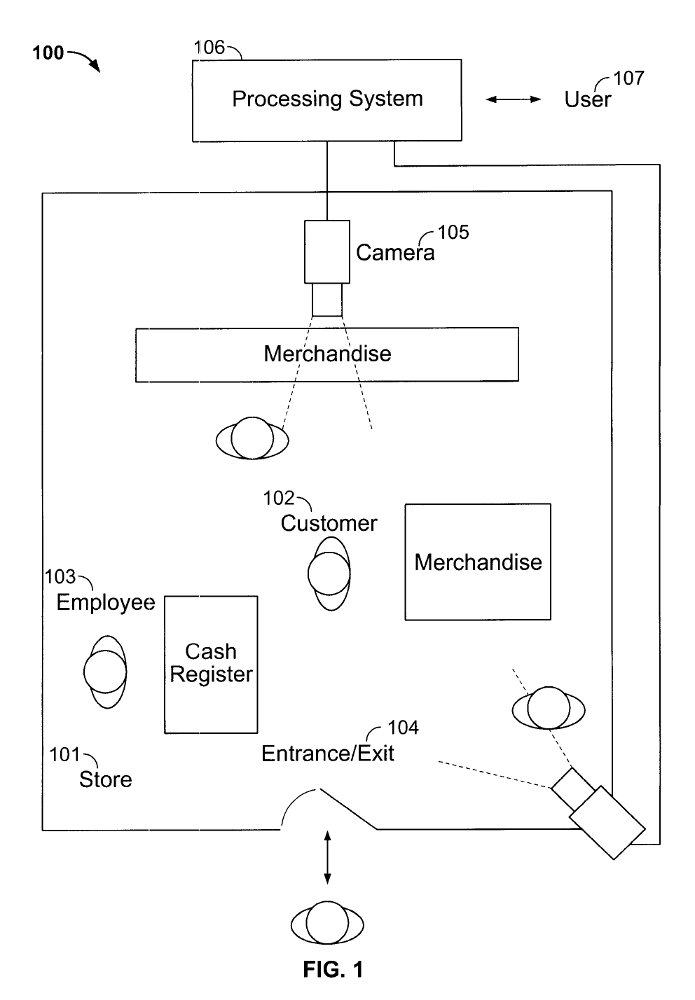

FIG. 1 illustrates a schematic view of a space 100 in accordance with the present invention. Note that the space 100 of FIG. 1 illustrates an environment of a retail store 101, however, the space can be in other environments as discussed above. The store 101 contains space through which people move, including, on more than one levels. Those people may be customers 102 shopping in the store 101 or employees 103 working for the store 101. People may enter or leave through entrances or exits 104, as shown in FIG. 1. These entrances or exits 101 may include either a one-way or two-way traffic. One or more sensors or cameras 105 are mounted, as shown, so that the field-of-view of the camera 105 includes image of at least part of the store 101. Note that the cameras 105 may preferably be mounted at many different positions other than those shown in FIG. 1, Video and image information is continuously captured by the cameras 105, which is retrieved by a processing system 106 to be processed for use. Note that the cameras 105 may preferably be cameras already installed in the store 101 or while some retail stores may want to install new or additional cameras, A user 107, preferably, an employee of the store, or alternatively, another interested party with authorization to use the information, interacts with the analysis module 106 to better understand the activity and/or behavior of customers and the operation of the store 101. Although not shown, note that the processing system 106 may preferably be installed in more than one store, and the users may use it to compare the activity and/or behavior of customers in different stores as well

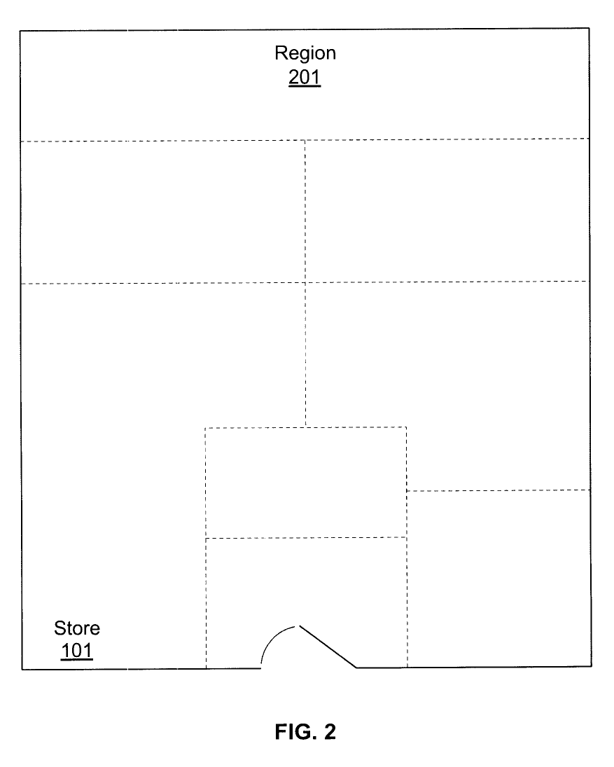

In one embodiment of the present invention the entire store 101 may be analyzed as a whole. In the preferred embodiment, the store 101 and/or store's floor area will be divided into regions 201 (a.k.a zones) as illustrated by the dotted lines in FIG. 2. These regions are defined prior to the implementation of the processing system 106. In one embodiment of the present invention, one may want to analyze the activity and/or behavior of customers in one or more regions 201 and in between the regions 201. In another embodiment, one may want to also compare the activity/and or behavior of customers in different regions 201 and in between the regions 201. Note that the regions 201 do not have to have simple relationships such that they do not need to be the same shape or size, nor do they have to be arranged in a fixed tiling pattern. Although FIG. 2 does not show a region with a curved boundary, the present invention allows regions with arbitrarily-shaped boundaries.

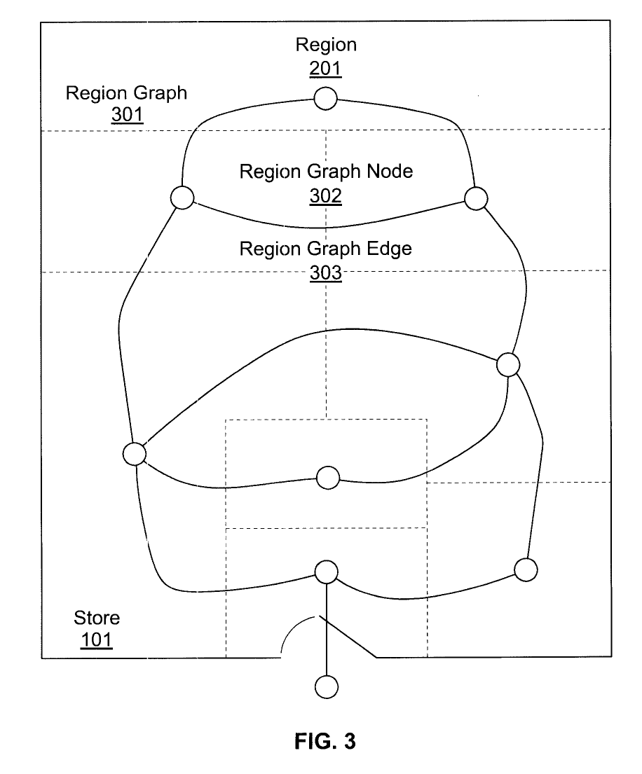

As shown in FIG. 3, one useful model for the regions in a store is the region graph 301. Similar graph models have been used to model two-dimensional areas in both building architecture and VLSI layout as known in the art. However, the region graph model in the present invention is used in novel ways. The region graph is composed of region graph nodes 302 and region graph edges 303, as illustrated, in FIG. 3, which may be referred to as simply nodes or edges. Each region 201 is assigned one region graph node 302. Also, a region graph node 302 is also assigned to the area beyond each entrance/exit 104. A region graph edge 303 connects two region graph nodes 302 if and only if the corresponding regions 201 are adjacent to each other, i.e. share an edge with one another. A region graph edge 303 represents the ability of people to move between, two regions 201. The structure of the region graph 301 shows various possible ways that people can move through the store between regions 201. Note that the present invention is not limited to the nodes 302 and the edges 303 as illustrated in FIG. 3 and there are other possible positions of the nodes and the edges indicating movement ability of the people.

System Architecture:

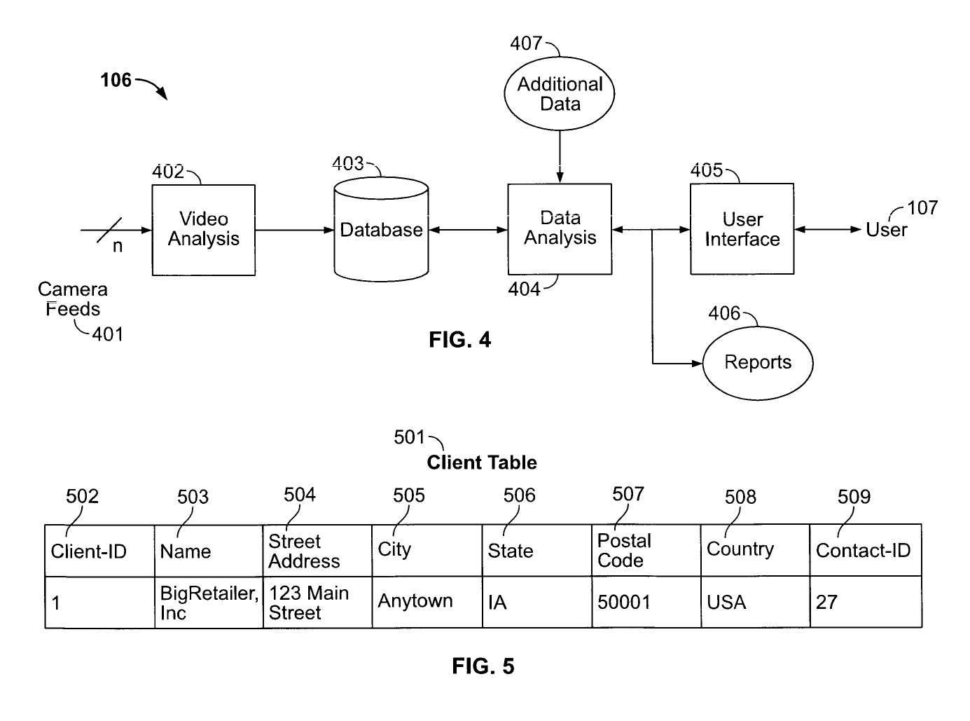

Referring to FIG. 4, there Is shown a block diagram of the processing system 106 according to one embodiment of the present invention. The system 106 typically includes one or more sensor/camera servers (not shown) configured to capture imagery or camera feeds 401 of a space, for example, the store 101. The camera feeds may preferably be In the form of still images or alternatively continuous video images, preferably, in real time. The camera feeds 401 may be supplied in analog or digital form, if analog, then they must be digitized before use. Analog camera feeds may he supplied, in a variety of known formats, .including but not limited to NTSC, PAL, SECAM, VHS, or component video. Digital camera feeds may similarly be many different formats, including but not limited to raw, JPEG, TIFF, GIF, MPEG-1, MPEG-2, MPEG-4, or H.264, in the preferred embodiment, the present invention provides camera, feeds in the form of JPEG encoded frames, desirably, supplied by a camera server manufactured by Yokogawa Electric Corporation, however other camera feed formats are well within the scope of this invention. Although, as expected that typical, installations will provide all camera feeds in the same format, the system of the present invention is capable of handling camera feeds of multiple formats,

FIG. 4 Is not concerned with the physical partitioning of the equipment that embodies these elements, and are not concerned here with what operations are done on the store premises and what operations are done on a server located elsewhere, for example. One can envision several different ways to physically partition the tasks of FIG. 4, depending on both technical considerations and the business model under which the retail analysts system is operated.

These camera feeds 401 are applied to a video analysis module 402, which uses algorithms described below to extract characteristics of customer activity and/or behavior from the imagery. The activity data records are then stored in the database 403. Note that the camera feeds 401 may also optionally be used for security purposes. The video analysis module 402 preferably generates a variety of statistics on the activities of people. The statistics may be determined from the analysis of a single frame or of multiple frames. The video analysis algorithms are described in more detail below. The activity data records determined by the video analysis module 402 may take a variety of forms. These activity data records are preferably in the form of events, although other forms of output could also be contemplated, within the scope of this invention. Each person in the field-of-view is recorded with his/her position, and if the person is in motion, the direction of movement is also recorded. These activity data records are stored into a database 403. The database 403 may be implemented in a variety of ways, including but not limited to relational, object-oriented, flat files, or a combination thereof. The current implementation uses a combination of my SQL and Hat files. Image files that show selected frames from the camera feeds 401 are preferably kept as separate files, while other data is stored preferably in the mySQL database.

The data analysis module 404 performs calculations and applies algorithms to the activity data in the database 403. The data analysis module may generate resulting data based on requests from the user interface 405 or alternatively generate resulting data as frequently running reports 406. The data analysis module 404 may optionally make use of secondary or additional, data 407. Examples of additional data 407 include but are not limited to sales data, calendar information such as holidays, weather information, mall traffic, or statistics from other stores. Alternatively, other data can be used, as would be known to one of skill in the art, as informed by the present invention. The data analysis module 404 will be described in more detail below.

One embodiment, as described above, uses a camera server from Yokogawa Electric to create JPEG files from analog imagery. This camera server is located within reasonable range of the camera, such as in a utility area of the store. The camera server sends the JPEG files over the Internet to the remainder of the system 106. In one embodiment, the functions of the video analysis 402, the database 403, and the data analysis 404 are performed preferably at a computer not located at the store. A web interface is preferably used to receive user requests and present output however, other architectures are also possible. The camera server can desirably perform at least some of the video analysis steps within the camera server. Alternatively, images can be stored in disks, thus eliminating the need to send data over large distances until they are required. This local storage of imagery is especially attractive when some image processing can be performed near the camera and only an abstraction of the imagery needs to be sent to remote locations.

Database:

Referring to FIGS. 5-9, there is illustrated a number of tables to organize the data in the database 403, preferably the mySQL database used in accordance with a preferred embodiment of the current application. For each table, the names of the attributes are listed in one row and sample values for these fields are provided in a separate row. In all cases, the first attribute serves as the primary id for the record. Note that the table design is exemplary but not limiting and other designs may be selected with different table organizations or somewhat different data to put into the database.

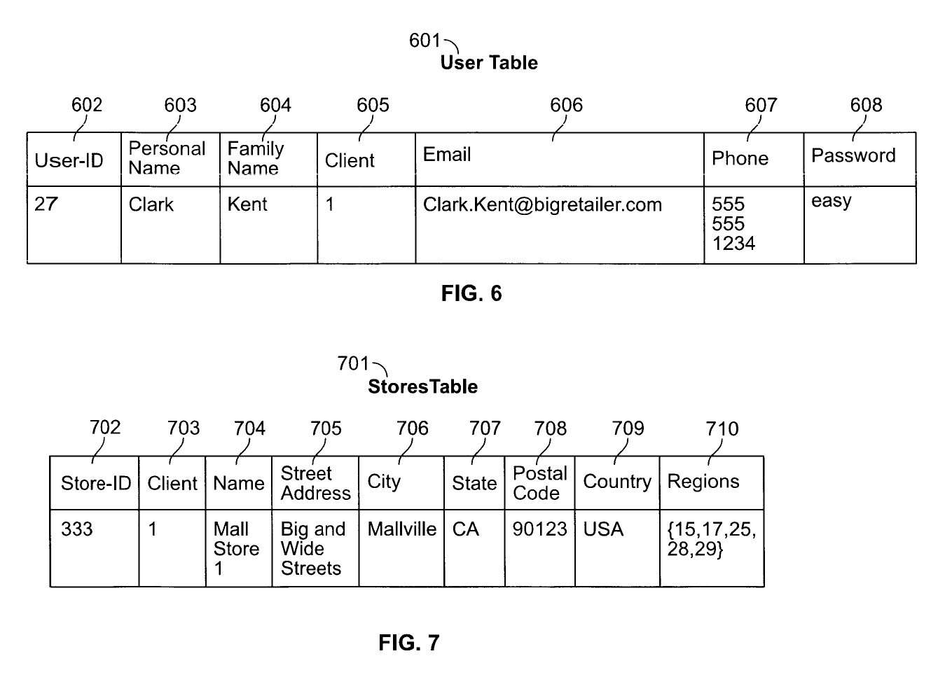

FIGS. 5 and 6 show exemplary tables used to organize clients and users. Attributes in the client table 501 of FIG. 5 preferably include client-id 502, name 503, street address 504 city 505, state 506, postal code or Zip Code 507, country 508, and the user table identifier for a contact person 509. The user table 601 of FIG. 6 describes individual users of the system. Attributes preferably include user-id, 602, personal name 603 (first name in Western cultures), family name 604 (last name in Western cultures), identifier for the client whom this user represents 605, email 606, phone 607, and password 608.

FIG. 7 illustrates an exemplary storage table 701. Attributes preferably include store-id 702, the identifier of the client, responsible for the store 703, name of the store 704, street address 705, city 706, state 707, postal code or Zip Code 708, country 709, and regions 710.

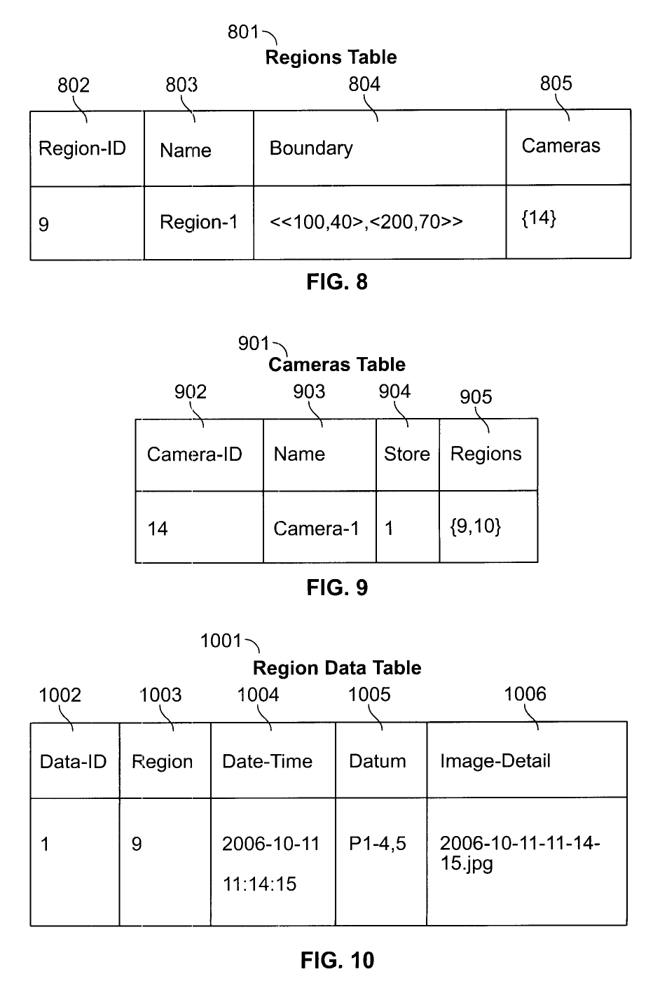

FIG. 8 shows an exemplary regions table 801 that describes the regions in stores. Attributes preferably include region-id 802, name 803, boundary 804, and cameras 805. The region is described as a bounding box, <<llx,lly>, <urx,ury>>, but other representations are within the scope of our invention. One or more cameras may generate information about different parts of the region.

FIG. 9 shows an exemplary cameras table 901. Attributes preferably include camera-id 901, name 902, identifier, for the store 904 that holds the camera 903, and identifiers regions 905 that the camera covers. The store 904 and region information 905 are redundant but may speed up some queries, if a camera covers more than one region or if a region is covered by more than one camera, then additional information, such as but not limited to boundary information in camera coordinates, can be stored by the system to allow the system to properly assign people to regions. However, some of that data may preferably be stored separately by the video analysis module 402 and not stored in the database 403.

FIG. 10 shows the region data table 1001. Attributes include data-id 1002, region 1003, date-time 1004, datum 1005, and image detail 1006. The datum 1005 describes the information extracted, from the imagery. The image detail 1006 gives the imagery associated, with the datum 1005. In our preferred embodiment, the JPEG files are stored outside the database but other organizations and image data formats are possible.

Video Analysis:

Embodiments of the video analysis module 402 consists of several object detection, and tracking algorithms that may be selected automatically to track individual objects (human) or group of objects based on the resolution and occlusion levels in the input videos. The module 402 can track people in crowded environments. The algorithms described herein are exemplary but other algorithms can be used to detect and analyze people. These algorithms could generate more or less data about the people, depending on their capabilities.

Different approaches exist for object detection and tracking. However most of these methods and systems are suitable to detect individual objects with Sow occlusion and high resolution levels. Furthermore, the extraction of object of interest (human) depends in general on the complexity of the background scene or the availability of the background scene without any foreground objects. It is the objective of the invention to overcome the disadvantages with the prior art in foreground object extraction, detection and tracking for smart camera systems.

The module 402 consists of several parts. The first component after the

initialization part is background, elimination part. After the initialization process to obtain a background model of the scene, this model is updated afterwards to adapt to changes in the scene due to view (e.g. lighting) or object (e.g. addition of new objects or change of location of background objects) based changes or camera movements. Then the extracted regions of foreground objects are analyzed, to detect the presence of object of interest and to estimate the congestion level in the scene. The congestion level along with estimated occlusion and resolution levels are used to select the appropriate tracking algorithm. The output of the flow estimation and tracking algorithms provides motion analysis for event and gesture detection. The tracking algorithm in this part is based on shape, color and motion patterns of object of interests (human). The aim is to use simple and fast algorithms to match low-level image features of segments in different frames while using a sophisticated algorithm to combine/segment the regions to connect them to high-level, attributes. The outcome of this algorithm is used for motion analysis including articulated movements, gestures, rigid movements for event classification. It is the objective of this system, to provide robust and reliable tracking of human even in the case of occlusion and view changes. The details of the system are more fully described in U.S. Pat. No. 7,200,266 B2, entitled, “Method and Apparatus for Automatic Video Activity Analysis”, the disclosure of which is incorporated herein by reference.

A benefit of embodiments of this system is the ability to detect people, their moving direction, e.g. left-right, the date and time, number of people who are in the store and\or who exited-entered the store, and give a general layout of the detected area with the person location on it. Additional information which can be calculated are date-time, moving direction, and number of people. Alternatively, other information can be calculated, as would be known to one of skill in the art, as informed by the present disclosure.

In one embodiment, the video analysis module 402 emits activity records in this form:

%02d-%02d-%02d%02d:%02d:%02d P=%d X=%d Y=%d BH=walk DIR=R FN=%d

Date (year, month, day), time (hour, minute, second), person number P, x and y coordinates, behavior=walk, direction=(it can be right, left, up, down), and frame number.

Some users or clients may not be concerned about counting employees in with customer activity, while others may want to separate employee and customer activity. In some cases, the employees can be visually separated from the customers because of the clothes they wear. Consider, for example, the orange worn by Home Depot employees. Another alternative technique for separating employee activity is to have employees wear some sort of active device, such as a beacon, RFID tag, or other module that can be used to determine their position. Position may be approximate or accurate; it may be determined continuously or intermittently. Based on information known to the system about the locations of the boundaries of the regions, the video analysis module 402 can determine what region 201 a person is in.

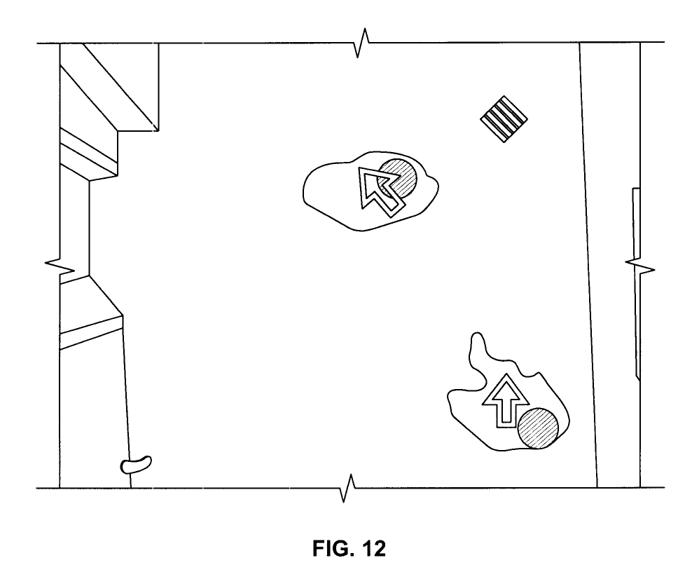

FIG. 12 shows a exemplary video frame with annotations showing the results of the video analysis module 402. This image is preferably taken from overhead but the video analysis module 402 is not limited to analyzing data from overhead cameras. The user may also wish to view imagery, either live or recorded. One simple and intuitive way to present such data is to allow the user to click on a map of the store and see the relevant imagery, perhaps also based on a time or time interval, given by the user. The imagery may be retrieved from the system or may be obtained from other sources.

Data Analysis:

An aspect of some embodiments of the present application is the ability to provide useful information preferably to the managers (or other employees) of retail stores and/or other facilities used by people. In this section, there is described methods for turning video analysis results into useful analytical results by the data analysis module 404.

Most of the data analysis techniques can be applied to regions in the store or area, ranging from a single region to all the regions. Generally, when a user 107 wishes to compare results from different stores, information about the correspondences between regions is preferably stored in the database 403. These correspondences may be determined in many different ways. For example, if similar store layouts are used at different locations, the correspondence may be trivial or simple. Two regions may be equivalent if they hold the same or similar merchandise, or if they play a similar role in the flow of people through, the store or area. So, for example, if the location of the merchandise by region is known, then the correspondences between regions with similar merchandise may be deduced. The correspondences may also be directly specified. Once the correspondences between regions in stores are entered into the system, those correspondences can be used to compare data between stores or areas.

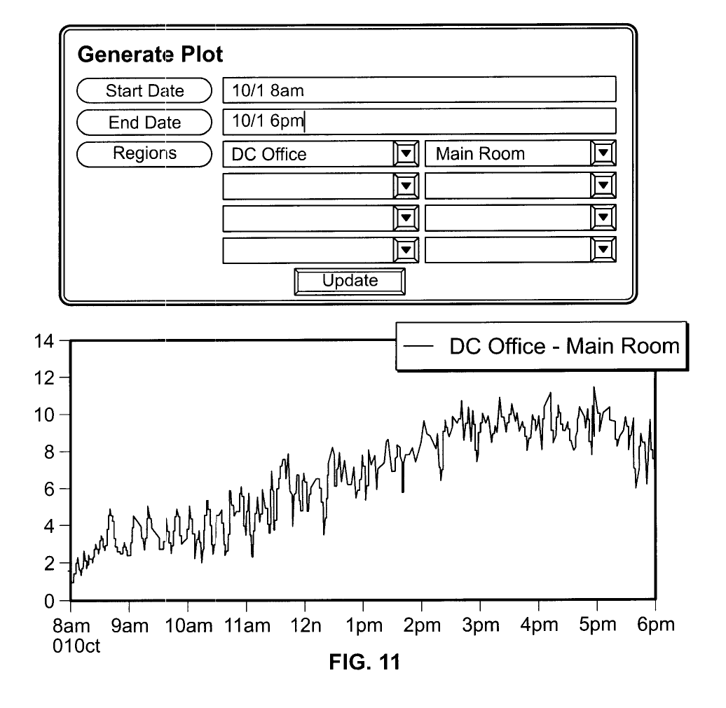

Another similarity among the various data analysis techniques is that they can be applied to intervals of time. Instantaneous measures of customer activity may be useful, but frequently users are interested in data over some interval of time, ranging from seconds or minutes to weeks or years. Data may be displayed as an aggregate value over the selected time interval or it may be shown as a table or graph that gives the variation in the value over time, FIG. 11 shows a sample web page from an exemplary user interface 405 with the data results generated by the data analysis module 404 in a graphical form, in accordance with one embodiment of the present invention.

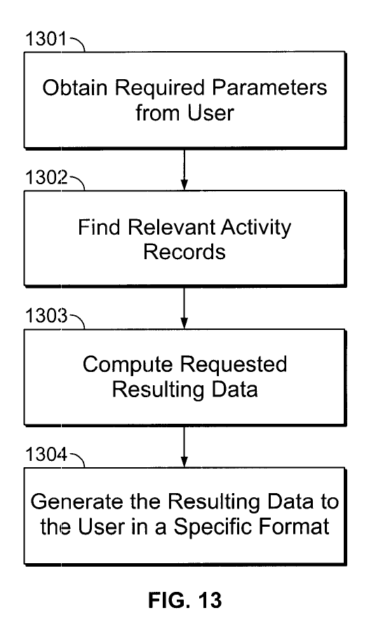

FIG. 13 shows an exemplary block diagram for processing a data analysis request from a user in accordance with one embodiment of the present invention. In step 1301, the required parameters from the user 107 are obtained. The parameters may vary based on the request, but could include region or regions, time or time interval, or other parameters. In step 1302, relevant records from the database 403 are searched. In step 1303, the required results data based on the records are computed by the data analysis module 404. The computations may preferably include, but are not limited to, adding data points over an interval, averaging, computing differences or ratios, or other known calculations well understood in the art of data analysis and presentation. Finally, in step 1304, the resulting data is a data analysis .result generated to the user 107 in a specific format, preferably in a display format.

In many cases, users may preferably be interested in a number of comparisons. A common comparison is activity in the same store from year-to-year or perhaps month-to-month or season-to-season. As mentioned above, users may also want to compare the results at one store to those of another. One important comparison is of store traffic and sales. For example, retail managers may want to know how the length of time which customers spend in a given region of the store correlates with the amount they spend on goods from that region. Sales figures an important category of the secondary or additional data 407 that can be used in data analysis. This sales data may be simple, such as total sales over a given interval, to very complex, such as SKU-oriented sales data, perhaps with customer data from affinity cards, or somewhere in between in complexity.

As discussed above, secondary data 407 may preferably include external data such as weather data, holidays or other events, such as civic events that may bring people into the area or draw them away from shopping. This external data could also become part of the analysis. Such detailed comparisons are not often made today because of the difficulty of gathering and correlating the necessary data. However, the present invention provides the simplicity with which the data analysis module 402 can perform such an analysis, thus making this sort of data comparison increasingly popular and in demand.

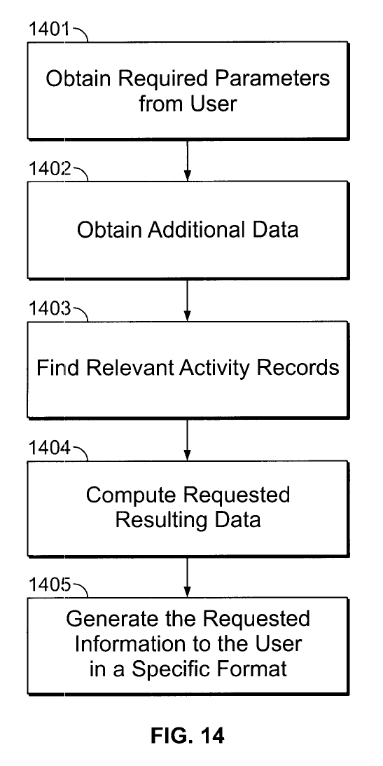

FIG. 14 shows an exemplary block diagram for processing a data analysis request with additional, information 407 in accordance with preferred embodiment of the present invention. In step 1401, the parameters from the user are received, which could be regions, time intervals, or other information. In step 1402, the required additional data or information 407 based upon, the user parameters is obtained. This additional information 407 may preferably be stored in the database 403 or alternatively may be obtained from other sources. In step 1403, the required customer activity records from the database 403 are obtained. Then, in step 1404, the requested information is computed by the data analysis module 404 and finally, in step 1405, this requested information is presented to the user as a data analysis result in any format, desired by the user. As discussed above, the computations are known calculations well understood in the art of data analysis and presentation. Also, as mentioned above, not all result data needs to be prompted by a user query, and can alternatively be provided based on pre-defined requirements.

A simple exemplary data analysis result is customer volume, or the number of customers at a given time or in a given interval. If all people are counted, the relevant metric is people volume. This can be computed per region or set of regions. It can be computed for a single time or for an interval. Customer volume can preferably be compared across different times at the same store or between stores. Using the video image of the region graph 300 as an example, the video analysis module 402 can determine the number of people in each region 201. The number of each people in a region 201 at a time or interval is an attribute of the node 302 that represents that region 201. So, as an example, initially, a count of number of people at nodes 301 and 302 of the region 201 is computed at a first time, example 10 am. The count at 10 am may include 10 people (for example) in the region 201 with node 301 and includes 5 people (for example) in the region 201 with node 302. Then, a count of number of people at nodes 301 and 302 is computed at a second time, example 10:30 am. The count at 10:30 am may include 7 people (for example) in the region 201 with node 301 and 8 people (for example) in the region 201 with node 302. With this difference in counts, the data analysts module 404 may preferably analyze that 3 people moved from region 201 with node 301 to the region 201 with node 302. This counting of number of people in nodes 301 and 302 is preferably repeated at different times to keep a count of number of people in each region at different times. The data analysis module 404 can also preferably analyze to determine the number of people based on the direction of movement from one region 201 to another as provided, by the video analysis unit 402.

Yet another useful activity or characteristic to measure is customer How (a.k.a. customer flux). Customer flow can preferably be compared across different times at the same space 101, ex: store or between stores 101. Using the video image of the region graph 300 as an example, video analysis module 402 can calculate flow between regions. As discussed above, the number of each people in a region 201 at a time or interval is an attribute of the node 302 that represents that region 201. Flow is a value assigned to an edge 303 between two regions 201. This can be computed per region 201 or set of regions 201, and it can be computed for a single time or for an interval. In the preferred embodiment of the present invention, initially, the direction of motion for each person, is determined by the video analysis module 402. This directionality information is used to estimate what edge 303, a customer will traverse while moving. Motion data will then predict customer counts at the nodes 301 at the next step. Significant differences between the prediction and the ultimate measurement may be used, for example, to detect anomalous customer activity or to detect in accuracies in video analysis module 402. The simplest case is to count the number of people leaving and entering the store at the entrances and exits. Then, these counts can be attached to the corresponding edges 303 in the region, graph 300. To calculate flows, the values of edges 303 at two different time or time intervals are used. The conservation of people principle, drawn from physics, states that people are neither created nor destroyed within the store. Thus, given the node values 302 at two different time intervals, the edge values 303, namely the flows are computed by the calculations understood in the art of data analysis as discussed above . Alternatively, if entrances and exits of the store are not measured, estimates or approximate values can be plugged into the calculations to obtain the flows.

Another interesting characteristic is dwell time, which is the amount of time that customers spend in a given region or set of regions, as measured over a given time interval. In one embodiment, the video analysis module 402 can track customers in order to measure the time each customer spends in a defined region or set of regions directly. Dwell time can be compared across different times at the same store or between stores.

Another important characteristic that is derived from a combination of video analysis module 402 and additional data 407 is merchandise conversion rate. While this can be written in more than one form, a common form is the dollars spent per customer in a given time interval and region. This can be computed over a set of regions and either instantaneous time or a user-specified time interval. Merchandise conversion rate can also be computed store-to-store and same store time-to-time. The item conversion rate is similar to merchandise conversion rate but sales for an item or set of items. Item conversion rate can be computed over a set of regions and either instantaneous time or a user-specified time interval. It can also be computed store-to-store and same store time-to-time.

In general, a variety of techniques can be used to implement the calculations described in the present invention. Simple calculations may preferably be performed in a Web interlace language such as PHP or equivalent languages, or similar methods in non-Web interfaces. More sophisticated calculations may be performed in separate programs that provide data to be integrated into the user interface display.

Some embodiments of the present invention have several advantages over the prior art. Compared to human observers, the present invention analyzes continuous activity, can observe many areas of a store or other space at once, and does not exhibit human biases. Compared to video analysis systems that simply detect and analyze people, the system of the present invention further analyzes raw video analysis data to provide useful application-oriented data for users. Moreover, the system's ability to compare traffic to sales, weather, mail traffic, other inside and outside events is one example of its ability to provide insight through analysis. Many prior art systems concentrate on a camera-by-camera view of the area, failing to integrate information into a useful form for users. The system of the present invention gives the user a unified understanding of the activity in the store or area being analyzed, whether the area is covered by a single camera or by multiple cameras. Moreover, the data analysis result relative to regions is very useful in retail and other variety of spaces.

It is to be understood that the exemplary embodiments are merely illustrative of the invention and that many variations of the above-described embodiments can be devised by one skilled in the art without departing from the scope of the invention. It is therefore intended that all such variations be included within the scope of the following claims and their equivalents.

What is claimed is:

1. A method for analyzing activity of people in at least one space, comprising the steps of:
a) dividing the space into predefined regions, wherein said predefined regions comprise areas of interest related to the activity of the people, said predefined region comprising at least one node and at least one edge connecting the nodes if the predefined regions are adjacent to one another ;
b) receiving video images from one or more sensors placed in the predefined regions in the space;
d) analyzing said video images relative to the predefined regions to determine movement of people within said predefined region and between said predefined regions, said analyzing step comprising determining direction of movement for at least one person, and estimating the edge based on the direction;
d) storing said movement data into a database;
e) computing resulting data based on the movement data, wherein said computed resulting data provides features related to the activity of people,

2. The method of claim 1 further comprising receiving parameters from the user to compute said resulting data, wherein said parameters comprise region, time Interval, merchandise, or combinations thereof.

3. The method of claim 2 further comprising providing additional data to compute said resulting data, said additional data comprise sales data, traffic data, weather data, holidays data, or combinations thereof.

4. The method of claim 3 wherein said features related to said activity data comprising identification of at least one person in said predefined region, position of the at least one person in said predefined region, dwell time of the at least of person in said predefined region, movement and direction of the movement of the at least one person in said pre-defined region, movement and the direction of movement of the at least one person between said pre-defined regions, type of the movement of the at least one person, number of people in a given pre-defined region, number of people moving between the predefined regions, date, time or combinations thereof.

5. The method of claim 4 wherein said resulting data comprise measure of the activity data based on said predefined regions, time intervals, secondary data or combinations thereof.

6. The method of claim 1 further comprising comparing said resulting data between said predefined regions.

7. The method of claim 1 further comprising comparing said resulting data between said spaces.

8. The method of claim 1 further comprising providing said computed resulting data to a user upon request.

9. The method of claim 1 further comprising generating said computed resulting data in a specific format.

10. A method for analyzing activity of people in at least one space, comprising the steps of:
a) dividing the space into predefined regions, wherein said predefined regions comprise areas of Interest related to the activity of the people;
b) receiving video images from one or more sensors placed in the predefined regions in the space;
c) analyzing said video images relative to the predefined regions to determine count data within said predefined regions, said analyzing step comprising
(i) obtaining a count of the number of people within at least first and second predefined regions at a first time,
(ii) obtaining a count of number of people within said at least .first and second predefined regions at a second time;
d) storing said count data into a database;
e) computing resulting data based on the count data, wherein said computed resulting data provides features related to the activity of people.

11. The method of claim 10 further comprising repeating steps (i) and (ii) at a different said first and second time.

12. The method of claim 10 wherein said analyzing step further comprising determining direction of the movement of the people between said first and second predefined regions.

13. A system, for analyzing activity of people in at least one space, said system comprising:
a) one or more sensors placed in predefined regions in the space to capture video images; said predefined, regions comprise areas of interest related to the activity of the people, said predefined region comprising at least one node and at least one edge connecting the nodes if the predefined regions are adjacent to one another;
b) an imagery analysis module coupled to said one or more sensors to receive and analyze said video images relative to the predefined, regions to determine movement of people within said predefined region and between said predefined regions, said imagery analysis module function to determine direction of movement for at least one person, and estimate the edge based on the direction;
c) a database coupled to the imagery analysis system to store the activity data;
d) a data analysis module coupled to the database to retrieve the movement data and compute a resulting data based on the movement data, wherein said resulting data provides features related to the activity of people.

14. A system for analyzing activity of people in at least one space, said system comprising:
a) one or more sensors placed in predefined regions in the space to capture video images; said predefined regions comprise areas of interest related to the activity of the people;
b) an imagery analysis module coupled to said one or more sensors to receive and analyze said video images relative to the predefined regions to determine count data within said predefined regions, said imagery analysis module function to obtain a count of the number of people within at least first and second predefined regions at a first time and to obtain a count of number of people within said at least first and second predefined regions at a second time;
c) a database coupled to the imagery analysis system to store the count data;
d) a data analysis module coupled to the database to retrieve the count data and compute a resulting data based on the count data, wherein said resulting data provides features related to the activity of people.

15. The system of claim 14 wherein said imagery analysis module function to obtain a count of the number of people within at least first and second predefined regions at a different first and second time.
